(19) United States
(12) Patent Application Publication
(10) Pub. No.: US 2024/0296993 A1
(43) Pub. Date: Sep. 5, 2024

(54) ENERGY TRANSFER ELEMENT MAGNETIZED AFTER ASSEMBLY

(71) Applicant: Power Integrations, Inc., San Jose, CA (US)

(72) Inventors: David Michael Hugh Matthews, Los Gatos, CA (US); William M. Polivka, Campbell, CA (US)

(73) Assignee: Power Integrations, Inc., San Jose, CA (US)

(21) Appl. No.: 18/665,535

(22) Filed: May 15, 2024

Related U.S. Application Data
(62) Division of application No. 17/137,759, filed on Dec. 30, 2020.

(51) Int. Cl. H01F 41/02; H01F 1/057; H01F 27/24; H01F 27/32; H01F 41/04; H02J 50/10

(52) U.S. Cl. CPC H01F 41/0273; H01F 1/057; H01F 27/24; H01F 27/325; H01F 41/04; H02J 50/10

(57) ABSTRACT

An energy transfer element comprises a magnetic core having a gap in a magnetic path. Magnetizable material producing an initial flux density is positioned in the gap. One or more power windings is wrapped around the magnetic path. When the magnetizable material is magnetized the flux density produced by the magnetized material is offset from the initial flux density. The core is a toroid magnetic core or is comprised of two core pieces. The magnetizable material is an unmagnetized magnet or a mixture of a suspension medium comprising uncured epoxy and magnetizable particles. The magnetizable particles are selected from a group comprising Neodymium Iron Boron (NdFeB) based materials or Samarium Cobalt (SmCo) based material.

### CROSS-REFERENCE TO RELATED APPLICATIONS

This application is a divisional of U.S. patent application Ser. No. 17/137,759, filed on Jan. 30, 2020, now pending, hereby incorporated by reference in its entirety.

### BACKGROUND INFORMATION

### Field of the Disclosure

The present invention relates generally to magnetic cores and more specifically to magnetic cores that may be used as energy transfer elements.

### Background

Electronic devices use power to operate. Switched mode power supplies are commonly used due to their high efficiency, small size and low weight to power many of today's electronics. Conventional wall sockets provide a high voltage alternating current. In a switching power supply, a high voltage alternating current (ac) input is processed by a switched mode power converter to provide a well-regulated direct current (dc) output through an energy transfer element. In operation, a switch is utilized to provide the desired output by varying the duty cycle, varying the switching frequency, or varying the number of pulses per unit time of the switch in a switched mode power converter.

The energy transfer element for a switched mode power converter generally includes coils of wire wound around a core of material with relatively high magnetic permeability, e.g. ferrite or steel. For energy transfer elements such as transformers and coupled inductors, the energy transfer element can also include a structure called a bobbin or alternatively, a coil former, which provides support for the coils of wire and provides an area for the core to be inserted so the coils of wire can encircle a portion of the core. The core provides a path for a magnetic field generated by an electric current in the coils of wire. There is often a discrete region of relatively low magnetic permeability introduced in the path of the magnetic field provided by the core, typically referred to as a gap. The length of the gap may be chosen to manage the distribution of energy in the energy transfer element. The material with relatively low magnetic permeability is typically air, and the gap is often referred to as an air gap, although the gap may contain other material with relatively low magnetic permeability, e.g. paper or varnish. In some compositions of magnetic core material, the gap is distributed uniformly throughout the material. The energy transfer element could also include a magnet, e.g. a permanent magnet, used with the core to provide flux density offset for the core of relatively high magnetic permeability material. The magnet could be inserted into the air gap of an energy transfer element. However, due to the changing magnetic fields of an energy transfer element, the permanent magnet may be susceptible to eddy currents. The eddy current can produce an undesirable power dissipation in the magnet. Furthermore, the inability to exactly match the thickness of the permanent magnet to the air gap dimensions may result in unacceptable tolerances and variability in the flux density offset rendering such schemes impractical in mass production of such energy transfer elements.

Power supplies for electronic equipment may benefit from a magnetic energy transfer element that provides a flux density offset without excessive power loss in operation and may be manufactured at relatively low cost.

### SUMMARY OF THE INVENTION

An energy transfer element comprises a magnetic core having a gap in a magnetic path. Magnetizable material producing an initial flux density is positioned in the gap. One or more power windings wrapped around the magnetic path. When the magnetizable material is magnetized the flux density produced by the magnetized material is offset from the initial flux density.

The core is a toroid magnetic core or is comprised of two core pieces.

The magnetizable material is an unmagnetized magnet or a mixture of a suspension medium comprising uncured epoxy and magnetizable particles. The magnetizable particles are selected from a group comprising Neodymium Iron Boron (NdFeB) based materials or Samarium Cobalt (SmCo) based material.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A and FIG. 1B illustrate the salient features of the construction of a prior art example energy transfer element that may be included in a power supply.

FIG. 2A and FIG. 2B graphically illustrate the relationships between magnetic flux density in an energy transfer element and the current in a power winding of the energy transfer element.

FIG. 3A and FIG. 3B illustrate the salient features of the core of an energy transfer element having unmagnetized and magnetized magnetic material in the gap.

FIG. 4A and FIG. 4B illustrate the salient features of the construction of the energy transfer element on the cores of FIG. 3A and FIG. 3B that may be included in a power supply.

FIG. 5 illustrates a cross-section of a magnetizer for magnetizing the energy transfer elements disclosed above.

FIG. 6A and FIG. 6B illustrate the salient features of the construction of a powder core with distributed gap, showing one segment of the core that includes a magnetizable magnetic material that is magnetized after assembly.

FIG. 7A and FIG. 7B illustrate the salient features of the construction of a powder core with distributed gap showing one portion of the core comprising particles of magnetizable magnetic material that is magnetized and assembled with another portion of the core having no magnetizable material.

FIG. 8A and FIG. 8B illustrate the salient features of another construction of a powder core with distributed gap showing one portion of the core comprising particles of magnetizable magnetic material that is magnetized and assembled with another portion of the core having no magnetizable material.

FIG. 9A and FIG. 9B illustrate the salient features of yet another construction of a powder core with distributed gap showing one portion of the core comprising particles of magnetizable magnetic material that is magnetized and assembled with another portion of the core having no magnetizable material.

FIG. 10A and FIG. 10B illustrate the salient features of the construction of a powder core with distributed gap showing multiple portions of the core comprising particles of magnetizable magnetic material that are magnetized and assembled.

FIG. 11 illustrates a cross-section of a magnetizer for magnetizing a bar comprising magnetizable magnetic material prior to the assembly of the powder cores of FIGS. 7A-B, 8A-B, 9A-B, and 10A-B.

FIG. 12 illustrates a cross-section of a magnetizer for magnetizing a bar comprising magnetizable magnetic material after assembly of a powder core in the geometry of FIG. 9B.

FIG. 13 illustrates a cross-section of a magnetizer for magnetizing a bar comprising magnetizable magnetic material after assembly of the powder core illustrated in FIGS. 6A-B.

FIG. 14A and FIG. 14B illustrate the salient features of the construction of a prior art example energy transfer element that may be included in a power supply.

FIG. 15A and FIG. 15B illustrate the salient features of the construction of an energy transfer element having unmagnetized magnetic material in the gap.

FIG. 16 illustrates a flowchart 1600 to assemble the energy transfer element 1500A, 1500B shown in FIGS. 1500A and 1500B, respectively.

FIGS. 17A-17F illustrate the salient features of the construction of an energy transfer element having unmagnetized magnetic material in the gap.

FIG. 18 illustrates a flowchart 1800 to assemble the energy transfer element shown in FIGS. 17A-17F.

FIGS. 19A-19F illustrate the salient features of the construction of an energy transfer element having unmagnetized magnetic material, where the thickness of the magnetic material is less than or equal to the gap.

FIG. 20 illustrates a flowchart 2000 to assemble the energy transfer element shown in FIGS. 19A-19F.

FIGS. 21A-121F illustrate the salient features of the construction of an energy transfer element having unmagnetized magnetic material in the gap having a thickness greater than the gap.

FIG. 22 illustrates a flowchart 2200 to assemble the energy transfer element shown in FIGS. 21A-21F.

FIGS. 23A-23F illustrate the salient features of the construction of an energy transfer element having deformable unmagnetized magnetic material in the gap.

FIG. 24 illustrates a flowchart 2400 to assemble the energy transfer element shown in FIGS. 23A-23F.

FIG. 25 illustrates a cross-section of a magnetizer 2500 for magnetizing the energy transfer elements disclosed above.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

It will be appreciated by those skilled in the art that magnetic assemblies and parts of magnetic assemblies may be described by various terms that are not necessarily technically accurate nor precise. For example, virtually any piece of magnetic material may be referred to as a magnetic core. A complete assembly of pieces of magnetic components exclusive of windings may also typically be referred to as a magnetic core.

One prior art method for increasing the energy storage capability of inductors operating in dc applications is permanent magnet biasing. Typically, magnetized permanent magnets are placed into the air gap before core pieces are assembled around coils of wire. Alternatively, magnetized permanent magnets may be attached to exterior surfaces of an energy transfer element after the core and coils are assembled.

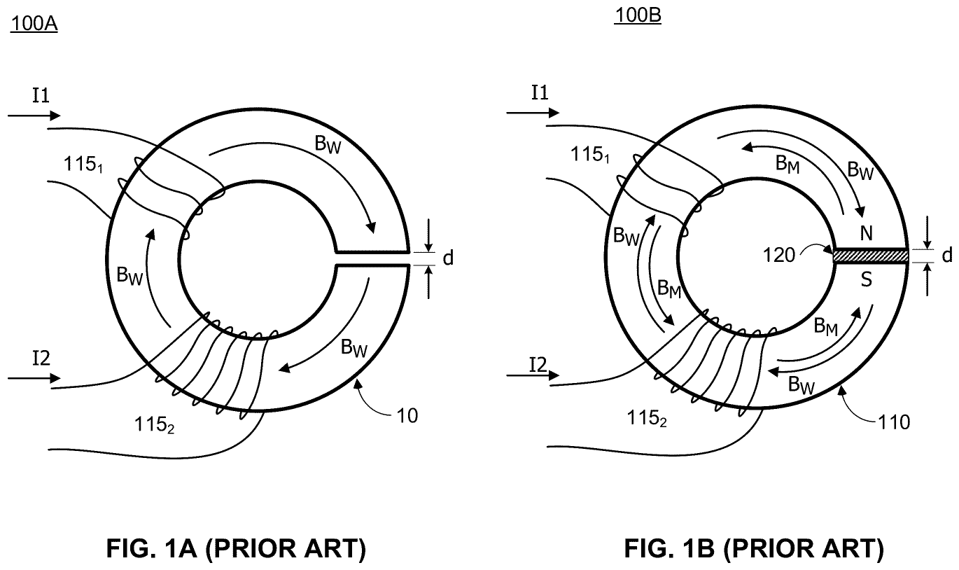

FIG. 1A and FIG. 1B illustrate the salient features of the construction of a prior art example energy transfer element that may be included in a power supply. FIG. 1A is a top view 100A that shows a toroidal magnetic core 110 having a primary winding 115₁ and a secondary winding 115₂. The magnetic path within the toroidal magnetic core 110 includes a gap of distance d. B_{W} indicates the magnetic flux density from the magnetic field for the equivalent power winding current, e.g. the summation of each current, I₁ and I₂, applied through the number of turns of its corresponding winding, typically referred to as the ampere-turns. The total magnetic flux density from the magnetic field produced by the windings is B_{W}. FIG. 1B is a top view 100B that shows a permanent magnet 115 inserted into the gap. B_{M} indicates the magnetic flux density from the permanent magnet 115 and is in opposition to the flux density B_{W} from the windings. The net magnetic flux density is the difference in magnitudes of the opposing flux densities, B_{W}-B_{M}.

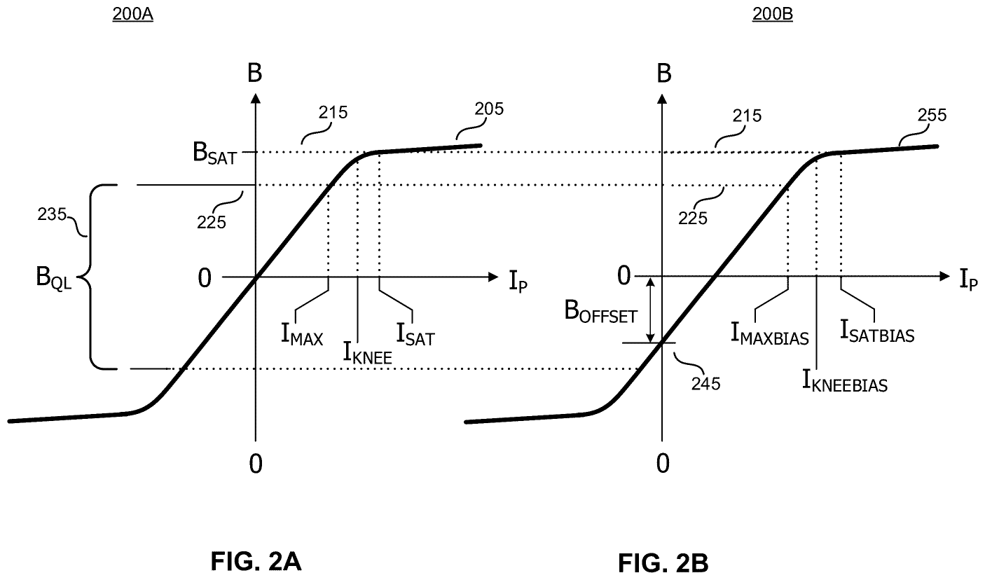

FIG. 2A and FIG. 2B graphically illustrate the relationships between magnetic flux density in an energy transfer element and the current in a power winding of the energy transfer element. FIG. 2A is a graph 200A that shows magnetic flux density plotted on the vertical axis with respect to an equivalent power winding current on the horizontal axis. The equivalent power winding current may be the sum of the ampere-turns in the windings of an energy transfer element. In the structure in FIG. 2A, for example, the current multiplied by the number of turns of winding 115₁ plus the current I₂ multiplied by the number of turns of winding 115₂ at any time would be the sum of the ampere-turns at that time. Current in the direction indicated by the arrow at the winding has a positive value, whereas current in the opposite direction has a negative value.

The materials with relatively high magnetic permeability, e.g. 1000 or more times the permeability of free space μ₀, used in energy transfer elements typically have negligible flux density when there is no current to produce a magnetic field. As such, they are not considered to be permanently magnetized, and they do not exhibit properties that we would typically expect of permanent magnets. Therefore, the relationships between magnetic flux density and current in FIG. 2A and FIG. 2B are single-valued, having only one value of flux density on the vertical axis for each value of current on the horizontal axis. These materials are considered not magnetized, and they cannot be permanently magnetized.

Materials for permanent magnets typically have multi-valued relationships between magnetic flux density and the magnetic field from an equivalent current. Exposure to a sufficiently strong magnetic field may change the state of the material from a first state or initial flux density, e.g. negligible flux density, to a second state that retains a relatively high magnetic flux density after the equivalent current is returned to zero. A material in the second state may be considered a permanent magnet that may introduce a desired flux density offset in an energy transfer element. These materials may be either magnetized or not magnetized, depending on their exposure to a magnetic field.

The example energy transfer element for the graph of FIG. 2A has no flux density offset from a permanent magnet, so the flux density is at zero when the current is at zero. The magnetic flux density curve 205 in FIG. 2A highlights several distinguishing features. The curve 205 takes on positive and negative values with symmetry about the origin on both axes. There is positive flux density for positive current and negative flux density for negative current. Features are emphasized for positive values of current in the graph because the equivalent current in typical energy transfer elements is in only one direction. As the current I_{P} increases from zero, the energy transfer element operates in a quasi-linear region B_{QL} 235 until the current reaches a maximum value I_{MAX} that corresponds to the upper boundary 225 of the quasi-linear region. The slope of the curve 205 in the quasi-linear region 235 is positive and relatively constant. In other words, the flux density increases with increasing current at a nearly constant ratio. As the current increases beyond I_{MAX}, the slope of the flux density curve 205 decreases, reaching a lower relatively constant value for currents greater than a saturation current I_{SAT} that corresponds to a saturation flux density B_{SAT} 215. Operation at higher values of flux density is likely to produce current that may damage switching devices and other components in a power supply. As the slope of the curve 205 changes from its nearly constant value in the quasi-linear region B_{QL} 235 where the current is less than I_{MAX} to its much lower nearly constant value where the current is greater than I_{SAT}, there is region where the slope is changing rapidly between the two nearly constant values. The current between I_{MAX} and I_{SAT} where the slope of the flux density is changing most rapidly is identified as I_{KNEE}since it corresponds to the relatively sharp bend in the flux density curve 205.

FIG. 2B is a graph 200B that shows magnetic flux density plotted on the vertical axis with respect to a power winding current I_{P} on the horizontal axis. In contrast to the graph of FIG. 2A, the example energy transfer element for the graph of FIG. 2B has a flux density offset from a permanent magnet.

The flux density offset from the permanent magnet shifts the curve 205 of FIG. 2A to the right on the horizontal axis as shown by the curve 255 in FIG. 2B. The values on the vertical axis for the saturation flux density B_{SAT} 215 and the quasi-linear region B_{QL} 235 are unchanged because they are intrinsic properties of the magnetic material of the core. A flux density offset can change the relationship between the flux density and an external stimulus, but it cannot change the intrinsic properties of the magnetic material. The flux density offset from a permanent magnet, such as for example one that may be placed in the gap of the assembly illustrated in FIG. 2A, is shown in FIG. 2B as B_{M} that produces a negative flux density 245 in the energy transfer element when the current I_{P} on the horizontal axis is zero.

The flux density offset increases the values of the current I_{P} required to reach the upper boundary 225 of the quasi-linear region B_{QL} 255, the saturation value B_{SAT} 215, and the flux density where the slope of the curve is changing most rapidly. In other words, currents I_{MAX}, I_{SAT}, and I_{KNEE} of FIG. 2A are respectively increased to I_{MAXBIAS}, I_{SATBIAS}, and I_{KNEEBIAS} in FIG. 2B. Therefore, an energy transfer element that uses a core with a permanent magnet to provide a flux density offset may store and transfer more energy for a given maximum current than the energy transfer element with no permanent magnet. This disclosure describes materials and methods to introduce permanent magnets into magnetic paths of energy transfer elements.

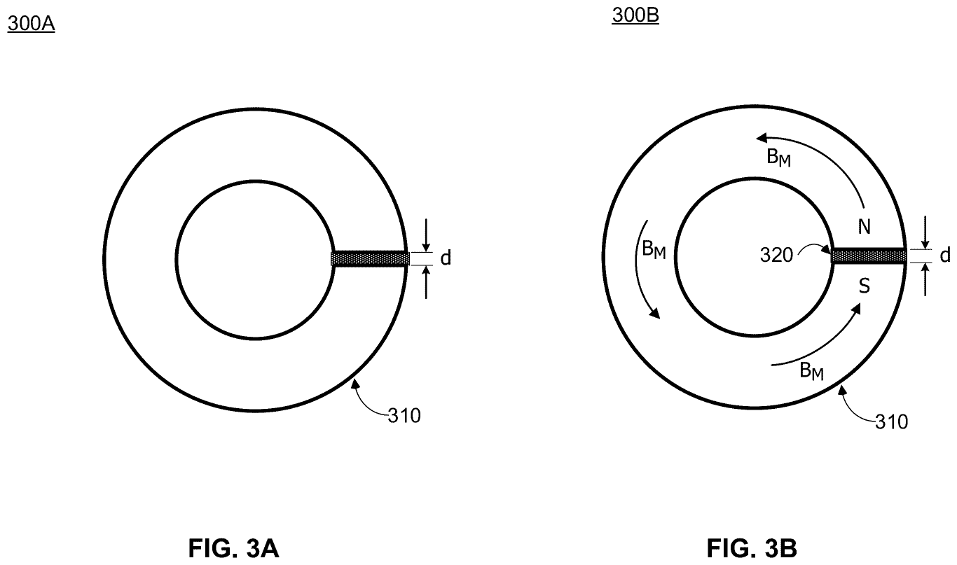

FIG. 3A and FIG. 3B illustrate the salient features of the construction of a magnetic core for an energy transfer element having unmagnetized and magnetized magnetic material in the gap. FIG. 3A is a top view 300A that shows a toroidal magnetic core 310 prior to magnetization. The magnetic path of the toroidal magnetic core 310 includes a gap of distance d. Unmagnetized magnetic material 320 is positioned in the gap. FIG. 3B is a top view 300B that shows after magnetization, the magnetic material 320 introduces the magnetic field B_{M} into the magnetic path of the magnetic core that may be used in an energy transfer element.

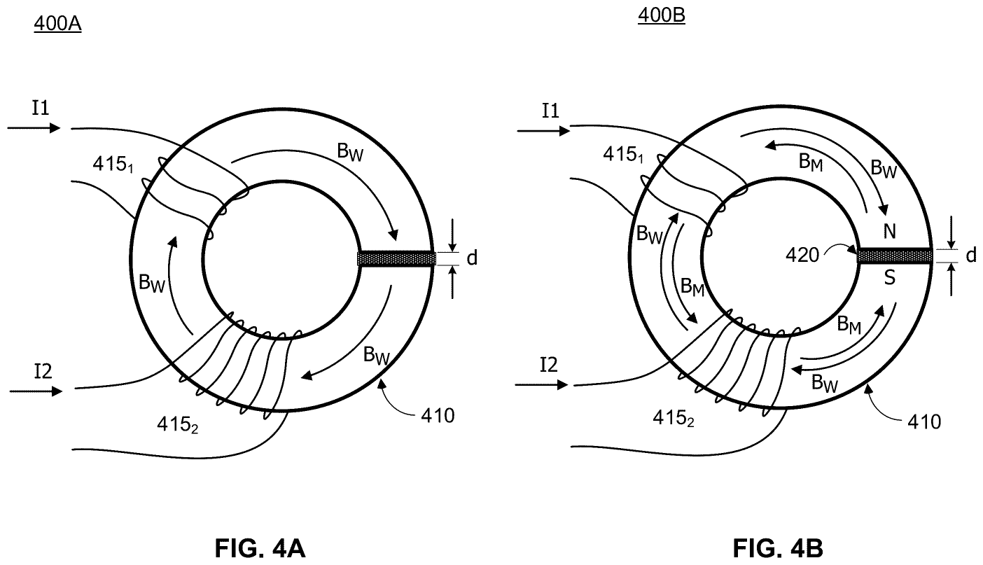

FIG. 4A and FIG. 4B illustrate the salient features of the construction of an energy transfer element from the cores of FIGS. 3A and 3B that may be included in a power supply. FIG. 4A is a top view 400A that shows a toroidal magnetic core 410, prior to magnetization, having a primary winding 415₁ and a secondary winding 415₂. The magnetic path of the toroidal magnetic core 410 includes a gap of distance d. B_{W} indicates the magnetic flux density for the equivalent power winding current, e.g. the summation of each current, I₁ and I₂, applied through its corresponding winding.

FIG. 4B is a top view 400B that shows after magnetization, the magnetic material 420 introduces the permanent magnetic field B_{M} into the magnetic path of the transfer element. The total magnetic flux density is the difference B_{W}-B_{M}.

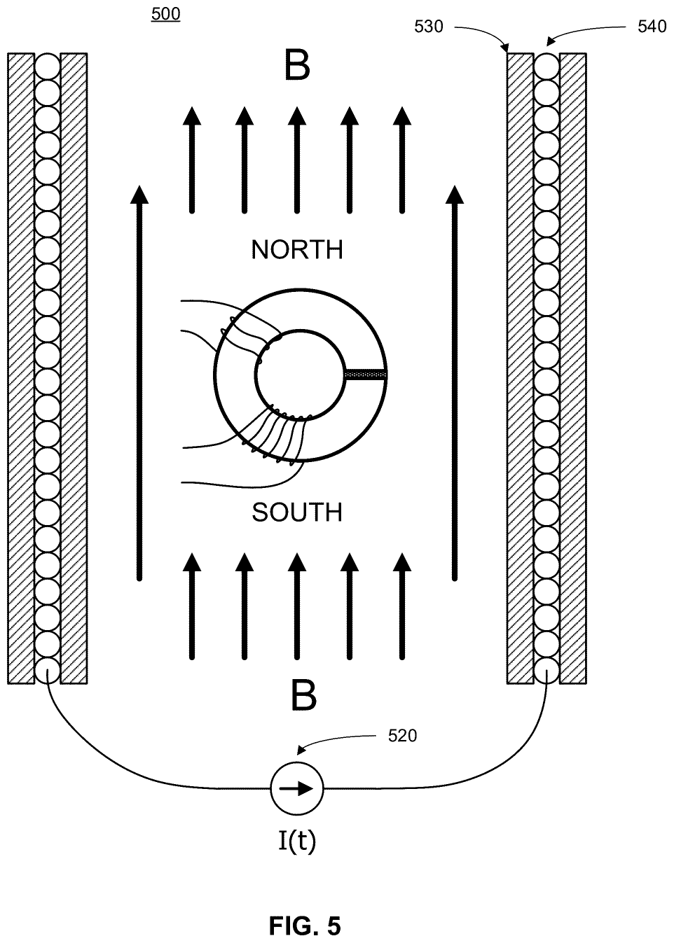

FIG. 5 illustrates a cross-section of a magnetizer for magnetizing the energy transfer elements disclosed above. The energy transfer element is placed inside the solenoid magnetizing fixture. The solenoid magnetizing fixture 500 is a double-walled cylinder 530 that sandwiches a solenoid conductor, e.g. a coil of wire, 540 between the walls. A current source 520 applies a current that is passed through the solenoid conductor to generate a magnetic field of a magnitude suitable to magnetize the permanent magnet material. In one example the permanent magnet material could comprise rare earth magnetic materials such as Neodymium Iron Boron (NdFeB), Samarium Cobalt (SmCo) or the like. For NdFeB materials, the magnetic field is typically greater than 3 tesla.

Magnetic cores can be fabricated from a homogeneous mixture of particles that comprise relatively high permeability material and relative low permeability material. When cast into a desired shape, the result is a core that has an air gap distributed uniformly through its volume. Cores of this composition are referred to as “powder cores” because the mixture is initially in the form of a powder. Energy transfer elements assembled from powder cores that have a distributed gap require no additional discrete air gap. Although powder cores may be procured in the same standard shapes and geometries as styles that have high magnetic permeability, it is common to cast the pieces into the form of a toroid that has no discrete gap.

The magnetic material in powder cores typically has relatively low residual flux density, and therefore they have negligible permanent magnetism. To obtain the benefits associated with a de flux density offset in an energy transfer element or in an inductor in a filter element, the mixture may include a powder of a rare earth alloy with permanent magnet properties such as NdFeB or SmCo.

The core may be cast with unmagnetized particles in the powder as usual. After the shape is cast, it may be magnetized with a current through a conductor that passes through an aperture in the core. It would not be sufficient to immerse either the core alone or the assembled energy transfer element in a magnetic field for magnetization since the permanent magnets are not localized to one small section of the core.

A toroid, for example needs to have the flux density offset in a direction that is everywhere perpendicular to the radius of the toroid. In other words, the magnetic flux density from the permanent magnet must be parallel to the magnetic field from the current in the windings. The core may be magnetized after it is assembled into an energy transfer element by passing sufficient current through a winding. Alternatively, the core may be magnetized before it is assembled into an energy transfer element by temporarily establishing a high current that passes through the aperture of the toroid.

It is not necessary for the geometry of the core to be a toroid with circular inner and outer circumferences. The powder core that contains permanent magnet material may be any shape that provides a closed magnetic path and an aperture for a conductor of current.

For purposes of illustration, the elements comprising only powder core are shown in the square pattern fill while elements that include magnetizable magnetic material are shown in the diamond pattern fill. The magnetizable magnetic material may be a mixture that contains particles of a binding compound such as for example epoxy and magnetic powder or a powder core material that further includes nonmagnetizable magnetic powder.

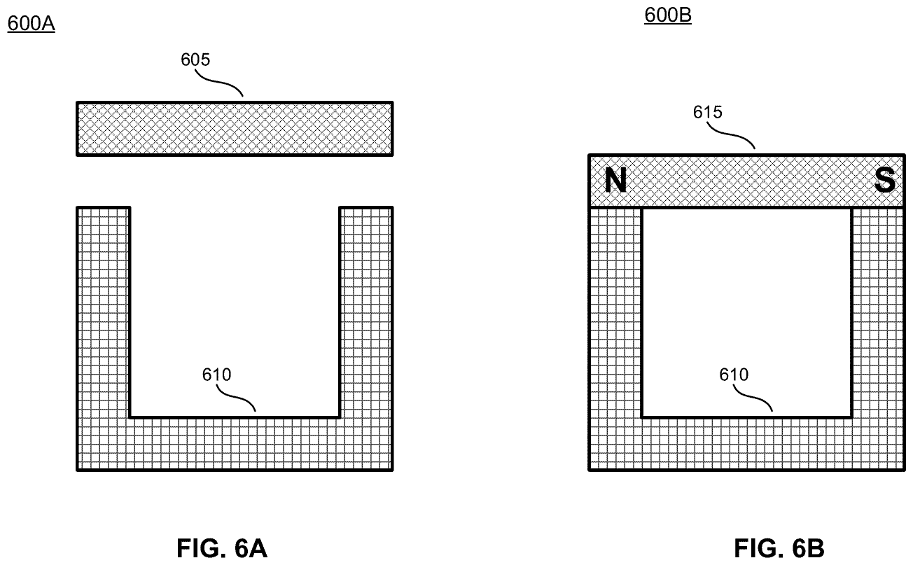

FIG. 6A and FIG. 6B illustrate the salient features of the construction of a core for an energy transfer element having unmagnetized magnetizable magnetic material and the composition of a powder core. FIG. 6A is a top view 600A that shows a U-shaped core 610 made from powder core. A bar 605comprising unmagnetized magnetizable magnetic material as well as the same nonmagnetizable material as in the U-shaped core 610 is positioned across the legs of the U-shaped magnetic core. FIG. 6B is a top view 600B that shows after assembly and magnetization, the magnetic material 615 is in the magnetic path of the U-shaped magnetic core. In practice, the magnetic flux density is not completely confined within the boundaries of the core, and some of the magnetic field will extend past the boundary defined by the U-shape.

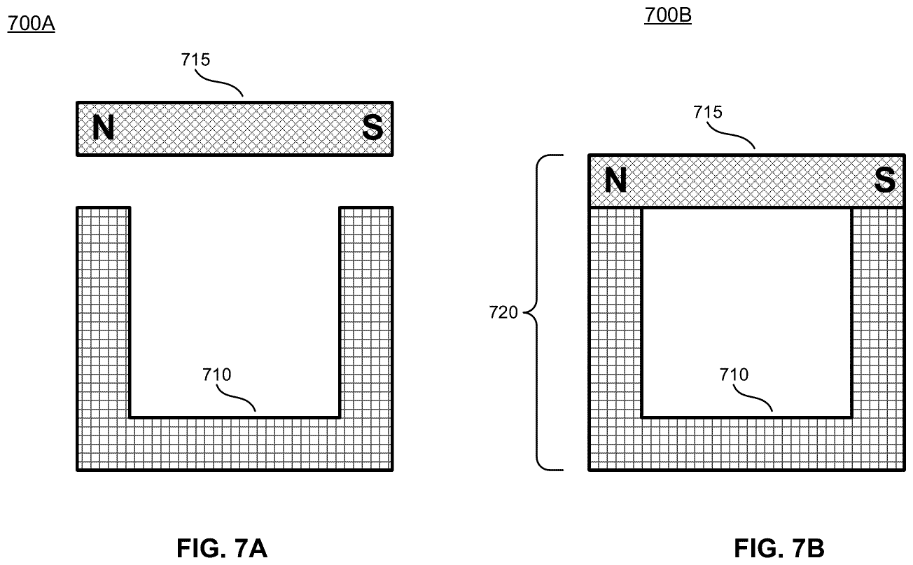

FIG. 7A and FIG. 7B illustrate the salient features of the construction of a powder core with distributed gap showing one portion of the core comprising particles of magnetizable magnetic material that is magnetized and assembled with another portion of the core having no magnetizable material. FIG. 7A is a top view 700A that shows a U-shaped magnetic core 710 and a bar of powder core containing magnetized magnetic material 715. FIG. 7B is a top view 700B that shows after assembly, the bar of powder core containing magnetized magnetic material 715 spans the legs of the U-shaped magnetic core. The structure 720 shows a closed magnetic path formed by the bar 715 and the U-shaped magnetic core 710. Since the magnetic flux density from the permanent magnet tends to extend linearly from the ends of the bar, the construction that spans the legs of the U-shaped portion is not optimum for inserting the flux density into the path of the field from the windings. Alternative constructions may be more effective in inserting the magnetic flux density from the bar section into the U-shaped section.

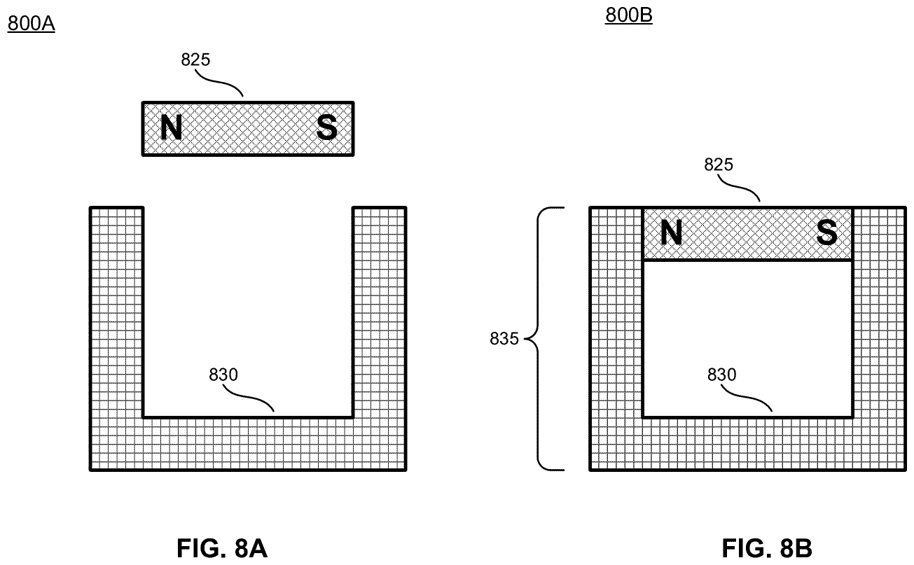

FIG. 8A and FIG. 8B illustrate the salient features of another construction of a powder core with distributed gap showing one portion of the core comprising particles of magnetizable magnetic material that is magnetized and assembled with another portion of the core having no magnetizable material. FIG. 8A is a top view 800A that shows a U-shaped magnetic core 810 and a bar comprising magnetized magnetic material 825. FIG. 8B shows a top view 800B where the bar of powder core containing magnetized magnetic material 825 interposes the legs of the U-shaped magnetic core. The structure 835 shows a closed magnetic path formed by the bar 825 and the U-shaped magnetic core 810. The magnetic path is within the boundary defined by the U-shape.

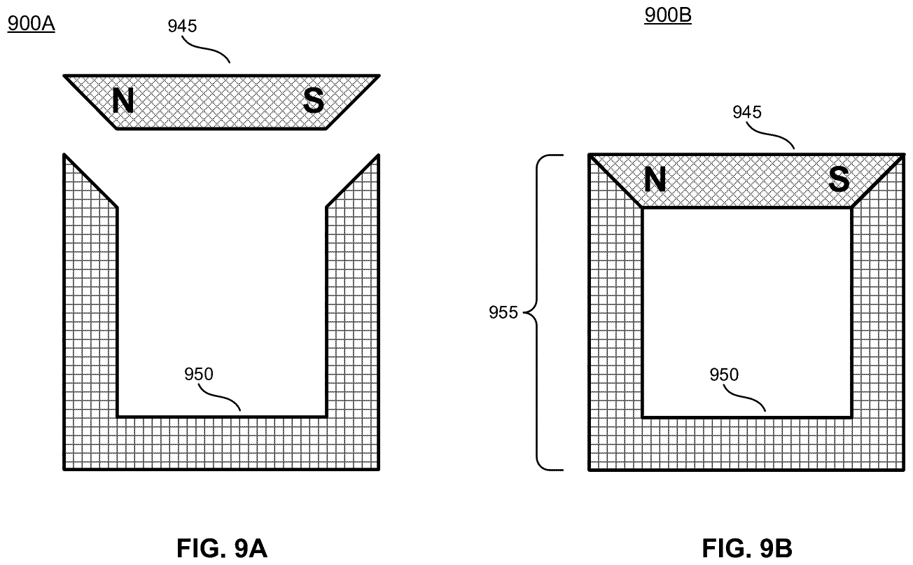

FIG. 9A and FIG. 9B illustrate the salient features of yet another construction of a powder core with distributed gap showing one portion of the core comprising particles of magnetizable magnetic material that is magnetized and assembled with another portion of the core having no magnetizable material. FIG. 9A is a top view 900A that shows a U-shaped powder core 910 having mitered corners and a bar of powder core containing magnetized magnetic material having mitered ends 925. FIG. 9B shows a top view 900B where the bar of powder core containing magnetized magnetic material 925 interposes the legs of the U-shaped powder core 910. The structure 935 shows a closed magnetic path formed by the bar 925 and the U-shaped magnetic core 910. The magnetic path is within the boundary defined by the U-shape.

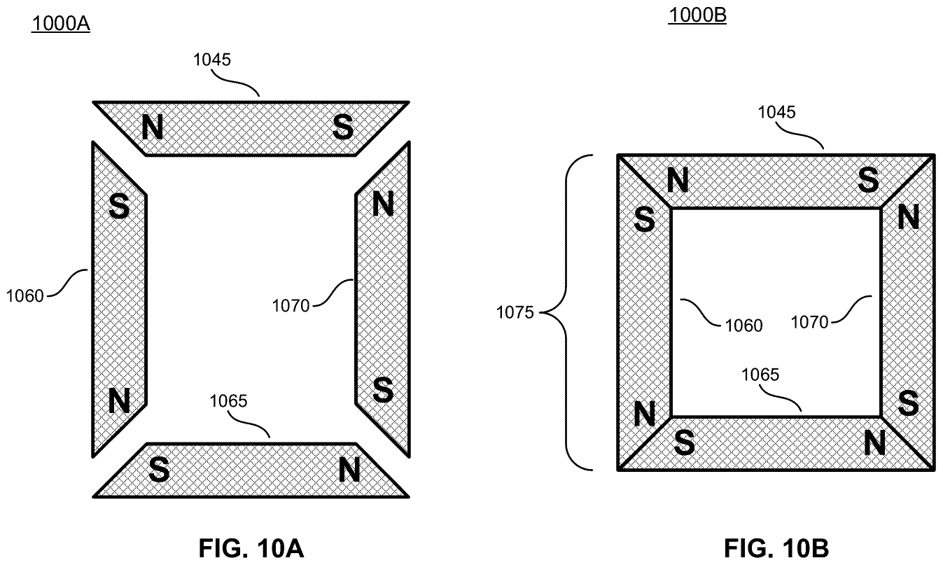

FIG. 10A and FIG. 10B illustrate the salient features of the construction of a powder core with distributed gap showing multiple portions of the core comprising particles of magnetizable magnetic material that are magnetized and assembled. FIG. 10A shows each side of the core is a bar of magnetic material 1045, 1065, 1060, 1070 formed from powder core that includes magnetizable powder. Each bar has a mitered end 1045, 1065, 1060, 1070 that mates to the surface of the end of an adjacent bar. The FIG. 10B is a top view 1000B that shows an assembled four-sided magnetic core structure 1075. The structure 1075 shows a closed magnetic path formed by the bars the U-shape.

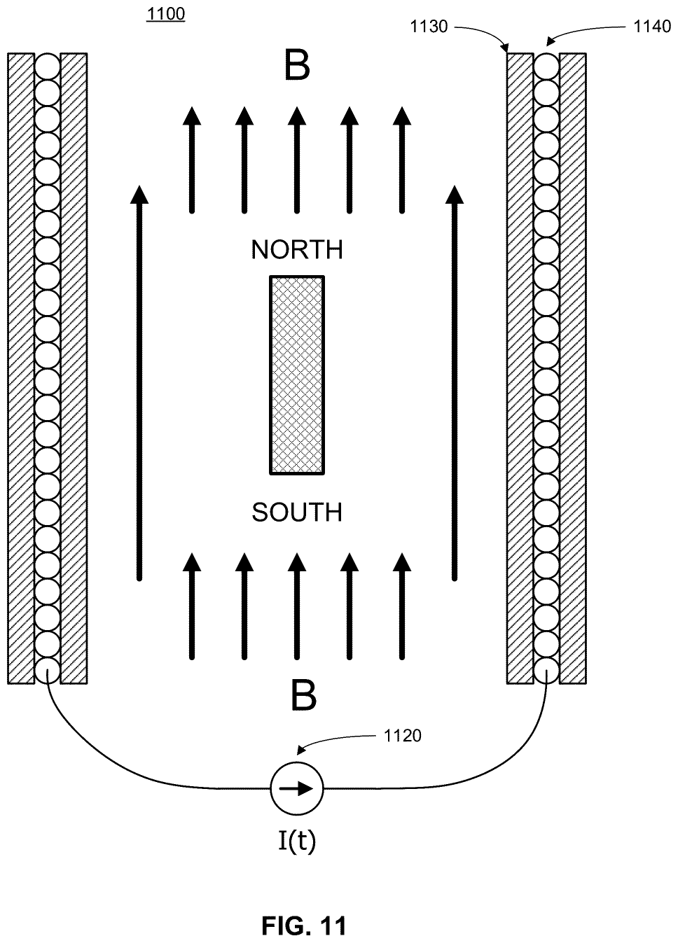

FIG. 11 illustrates a cross-section of a magnetizer for magnetizing a bar of magnetizable magnetic material prior to the assembly of the cores of FIGS. 7A-B, 8A-B, 9A-B, and 10A-B. The energy transfer element is placed inside the solenoid magnetizing fixture. The solenoid magnetizing fixture 1100 is a double-walled cylinder 1110 that sandwiches a solenoid conductor, e.g. a coil of wire, 1115 between the walls. A current source 1120 applies a current that is passed through the solenoid conductor to generate a magnetic field of a magnitude suitable to magnetize the bar of magnetic material.

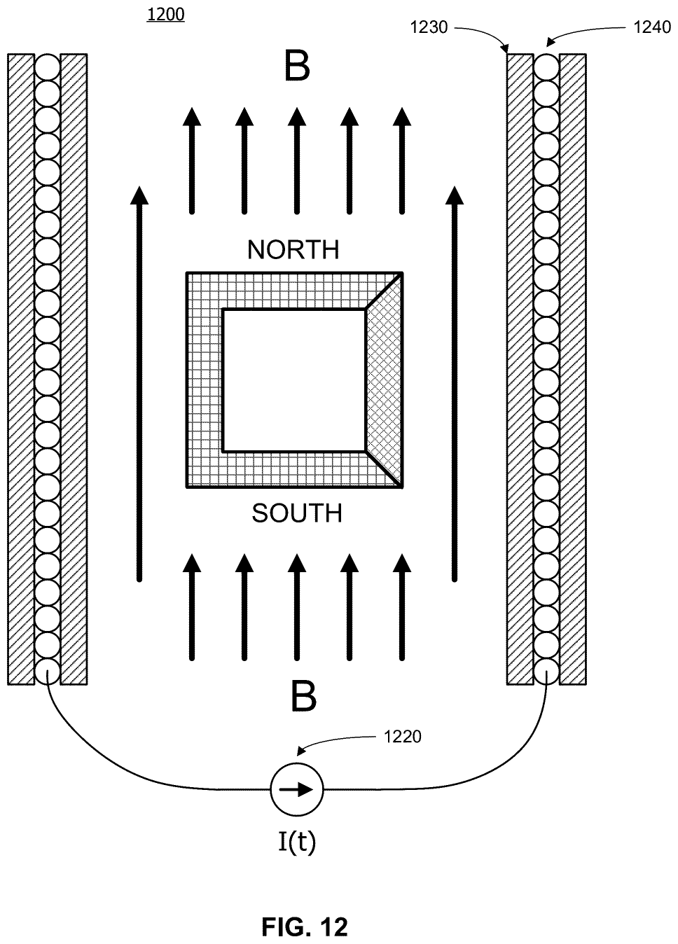

FIG. 12 illustrates a cross-section of a magnetizer for magnetizing a bar of magnetizable magnetic material after assembly of the energy transfer element of FIGS. 9A-B. The assembled energy transfer element is placed inside the solenoid magnetizing fixture. In the example of FIG. 12, the bar comprising magnetizable material is oriented such that after magnetization, the north pole N is upward and the south pole S is downward. The solenoid magnetizing fixture 1200 is a double-walled cylinder 1210 that sandwiches a solenoid conductor, e.g. a coil of wire, 1215 between the walls. A current source 1220 applies a current that is passed through the solenoid conductor to generate a magnetic field of a magnitude suitable to magnetize the bar of magnetic material.

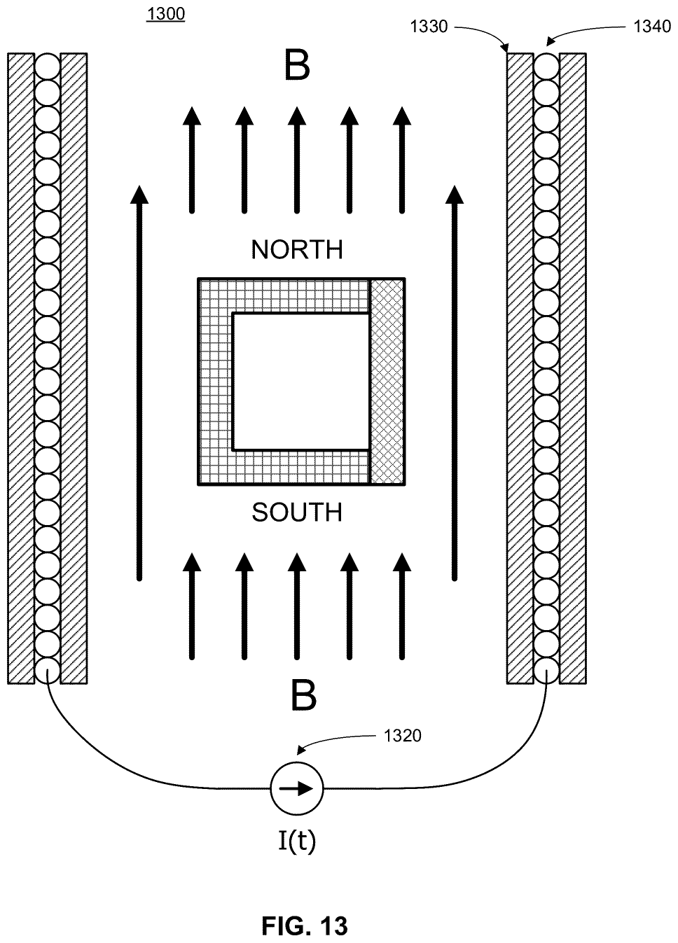

FIG. 13 illustrates a cross-section of a magnetizer for magnetizing a bar comprising magnetizable magnetic material after assembly of the energy transfer element of FIGS. 6A-B. The assembled energy transfer element is placed inside the solenoid magnetizing fixture. The bar comprising magnetizable material is oriented such that after magnetization, the north pole N is upward and the south pole S is downward. The solenoid magnetizing fixture 1300 is a double-walled cylinder 1310 that sandwiches a solenoid conductor, e.g. a coil of wire, 1315 between the walls. A current source 1320 applies a current that is passed through the solenoid conductor to generate a magnetic field of a magnitude suitable to magnetize the bar of magnetic material.

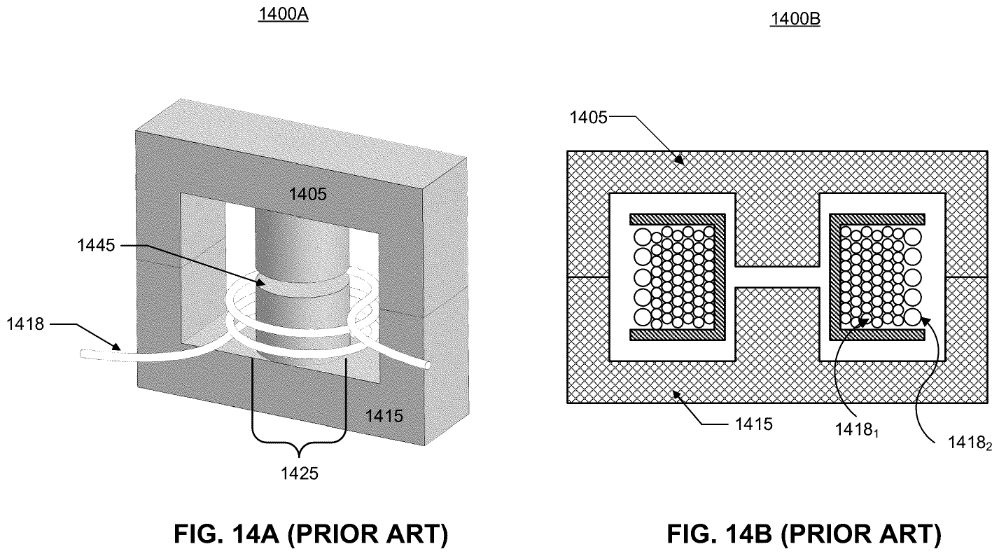

FIG. 14A and FIG. 14B illustrate the salient features of the construction of a prior art example energy transfer element that may be included in a power supply. FIG. 14A is a perspective view 1400A that shows an upper core piece, e.g. an upper magnetic core-half 1405, assembled over a lower core piece, e.g. a lower magnetic core-half 1415. Each magnetic core-half has a center post 1425 surrounded by a winding 1418 that represents one or more power windings. In a practical component, the turns of the power windings typically would be placed on a separate spool, sometimes referred to as a bobbin or a coil former, that would fit over the center posts to facilitate assembly. FIG. 14A shows a gap 1445 in the center post 1425 of the assembled core-halves. The dimension of the gap is typically selected along with the number of turns on the power windings to set the electrical parameters desired for a particular application.

FIG. 14B is a cross-sectional view 1400B of the prior art example energy transfer element of FIG. 14A with the upper core-half 1405 and lower core-half 1415 having two power windings 1418₁, 1418₂. The primary power winding 1418₁ is represented by the smaller circles wrapped closest to the spool of the bobbin. The secondary power winding 1418₂ is represented by the large circles which are wrapped on the bobbin 1435 over the primary power winding.

It will be appreciated by those skilled in the art that magnetic assemblies and parts of magnetic assemblies may be described by various terms that are not necessarily technically accurate nor precise. For example, virtually any piece of magnetic material may be referred to as a magnetic core. A complete assembly of pieces of magnetic components exclusive of windings may also typically be referred to as a magnetic core. Assemblies of magnetic cores typically comprise two core pieces. In many assemblies of magnetic cores, such as in the example of FIG. 14A, the two core pieces may be nearly identical. Hence, each core piece may be commonly referred to as a core member or core-half. In practice, the gap in a center post 1425 in the assembly of FIG. 14A for example, may be formed by removing material from the center post of only one of two identical core-halves. Each piece is still referred to as a core-half even though the piece that forms the gap is no longer identical to the piece that had no material removed. The assembly may be further referred to as a core pair. In this disclosure the term core-half may be used to refer to one of two nearly identical pieces, for example 1405 and 1415, in an assembly to distinguish the assembly from alternative assemblies comprising pieces that are obviously not identical. For example, an assembly of two E-shaped pieces such as 1405 and 1415 may have the same geometrical features and magnetic properties as an assembly that uses one E-shaped piece with one I-shaped piece. The EE assembly comprises two core-halves whereas the EI assembly does not, although each assembly comprises two core members. It is noted that in the practice of the art each one of a magnetic core piece, a magnetic core member, a magnetic core element, a magnetic core-half, and a magnetic core assembly may be referred to as a magnetic core which does not imply any permanent magnet properties of the core but typically refers to the core material having relatively high magnetic permeability. The magnetic energy transfer element of FIG. 14 can therefore be described as having a magnetic flux path comprising a region of relatively high magnetic permeability core material and a gap region having a low permeability which will be close to the permeability of free space.

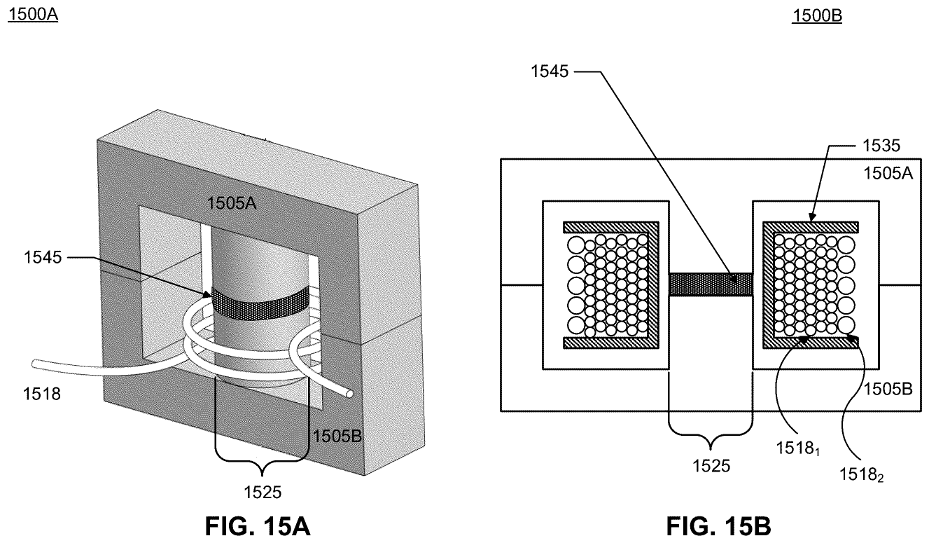

FIG. 15A and FIG. 15B illustrate the salient features of the construction of an energy transfer element having unmagnetized magnetic material in the gap. The gap is within an optional center post. FIG. 15A is a perspective view 1500A that shows an upper core piece, e.g. an upper magnetic core-half 1505, assembled over a lower core piece, e.g. a lower magnetic core-half 1515. In combination, the magnetic core halves form a center post 1525 surrounded by a winding 1518 that represents one or more power windings. In a practical component, the turns of the power windings typically would be placed on a separate spool, sometimes referred to as a bobbin or a coil former, that would fit over the center posts to facilitate assembly. FIG. 15A shows unmagnetized magnetic material in the center post of the assembled core-halves. The dimension of the gap is typically selected along with the number of turns on the power windings to set the electrical parameters desired for a particular application.

FIG. 15B is a cross-sectional view 1500B of an example energy transfer element using the construction of FIG. 15A with the upper core-half 1505 and lower core-half 1515 having two power windings. The smaller circles wrapped closest to the spool of the bobbin represent a primary power winding. The large circles represent a secondary power winding that is wrapped over the primary winding on the spool of the bobbin. The unmagnetized magnetic material 1545 fills the region of the gap between the upper core-half 1505 and the lower core-half 1515.

There may be an optional varnish coating (not shown) to seal the assembly.

The assembled energy transfer element 1500A, 1500B may be subject to an external magnetic field to permanently magnetize the magnetizable material 1545 in the gap.

The magnetizable material may be a suspension mixture that contains magnetizable powder along with a suspension medium which can be an adhesive or epoxy or be an unmagnetized magnet.

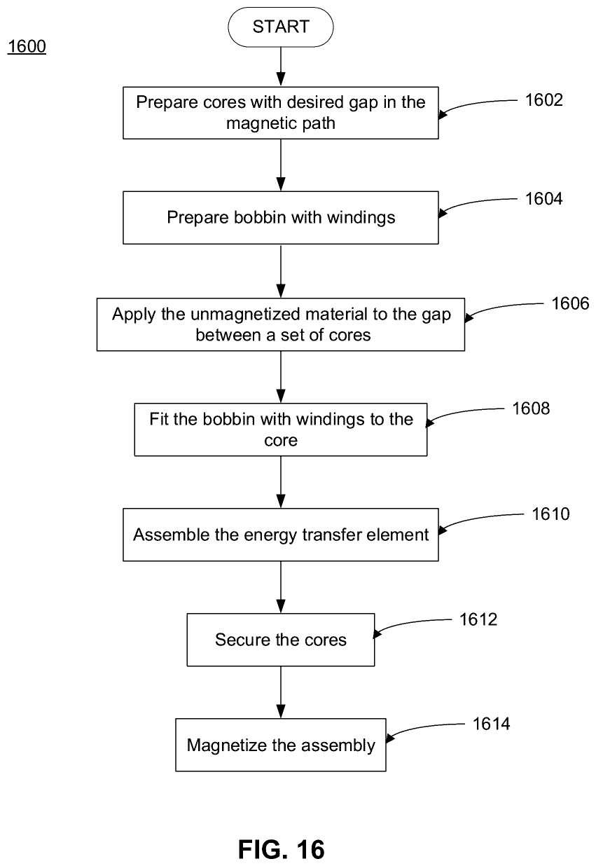

FIG. 16 illustrates a flowchart 1600 to assemble the energy transfer element 1500A, 1500B shown in FIGS. 1500A and 1500B, respectively.

In step 1602, the cores are prepared with a desired gap in the magnetic path.

In step 1604, the bobbin is prepared with windings.

In step 1606, the unmagnetized material is applied to the gap between a set of cores.

In step 1608, the bobbin with windings is fit to the core.

The order of steps 1606 and 1608 are interchangeable.

In step 1610, the energy transfer element is assembled.

In step 1612, the cores are secured.

In step 1614, the energy transfer assembly is magnetized.

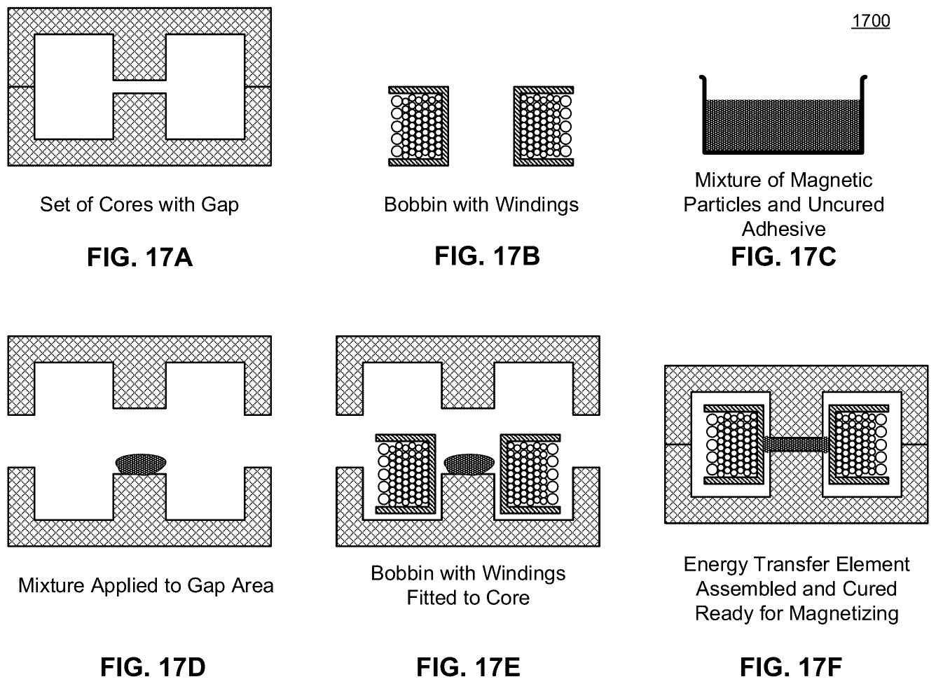

FIGS. 17A-17F illustrate the salient features of the construction of an energy transfer element 1700 having unmagnetized magnetic material in the gap between two core halves wherein the finished assembly in FIG. 17F is ready for magnetizing in accordance with the teachings of the present invention.

FIG. 17A illustrates a cross-section of a set of cores with a gap.

FIG. 17B illustrates a cross-section of a bobbin with windings. The primary power winding is reflected by the smaller circles wrapped closest to the spool of the bobbin. The secondary power winding is reflected by the large circles which are wrapped away from the spool of the bobbin.

FIG. 17C represents a mixture of unmagnetized magnetic particles and uncured adhesive in a container. The mixture has the material properties of being electrically relatively high impedance and adhesive. Initially, the mixture is in a liquid phase, and after a process of binding or curing the mixture changes to a solid phase. The liquid phase has a viscosity such that the mixture maintains a uniform distribution of the unmagnetized particles. The solid phase may be a rigid solid.

The mixture is configured to wet a surface of the unmagnetized particles. The mixture has adhesive and cohesive properties sufficient to keep the particles in suspension and remain substantially electrically insulated from each other during the process of assembling, curing, and magnetizing such that the mixture has substantially higher electrical impedance than the unmagnetized particles alone before mixing with the suspension medium. Suitable suspension mediums are epoxies or similar materials.

The unmagnetized material consists of particles capable of permanent magnetic properties when magnetized. These materials include rare earth materials such as Neodymium Iron Boron (NdFeB) based material and Samarium Cobalt (SmCo) based material.

In combination, the volumetric ratio of unmagnetized particles to suspension medium is typically greater than 1.

FIG. 17D shows the mixture applied to the gap area.

FIG. 17E shows the bobbin with windings fitted to the core.

FIG. 17F illustrates an energy transfer element that is assembled and cured. The completed element is ready for magnetizing. The mixture has been formed by the force of assembly to fill the gap region and may optionally be extruded from the gap to secure the bobbin to the post.

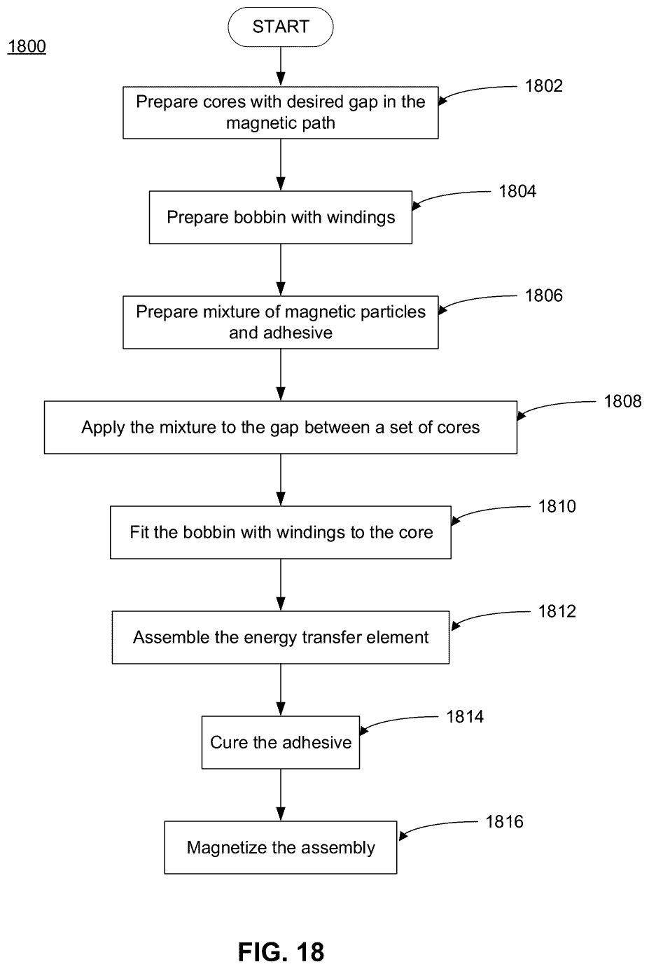

FIG. 18 illustrates a flowchart 1800 to assemble the energy transfer element 1700 shown in FIGS. 17A-17F.

In step 1802, the cores are prepared with a desired gap in the magnetic path.

In step 1804, the bobbin is prepared with windings.

In step 1806, the mixture of magnetic particles and suspension medium such as adhesive or epoxy is prepared. This step may occur at any point before step 1808.

In step 1808, the mixture is applied to the gap between a set of cores.

In step 1810, the bobbin with windings is fit to the core.

The order of steps 1808 and 1810 are interchangeable.

In step 1812, the energy transfer element is assembled.

In step 1814, the adhesive is cured. Curing may be achieved by several techniques. In one technique, the temperature is raised to above the curing temperature of the epoxy. In another technique, the pressure is raised to above a curing pressure associated with the curing material. In another technique, the epoxy is cured by radiation at a wavelength associated with the curing material. For each curing technique, the curing operational parameter is maintained to allow time for epoxy to cure.

In step 1816, the energy transfer assembly is magnetized.

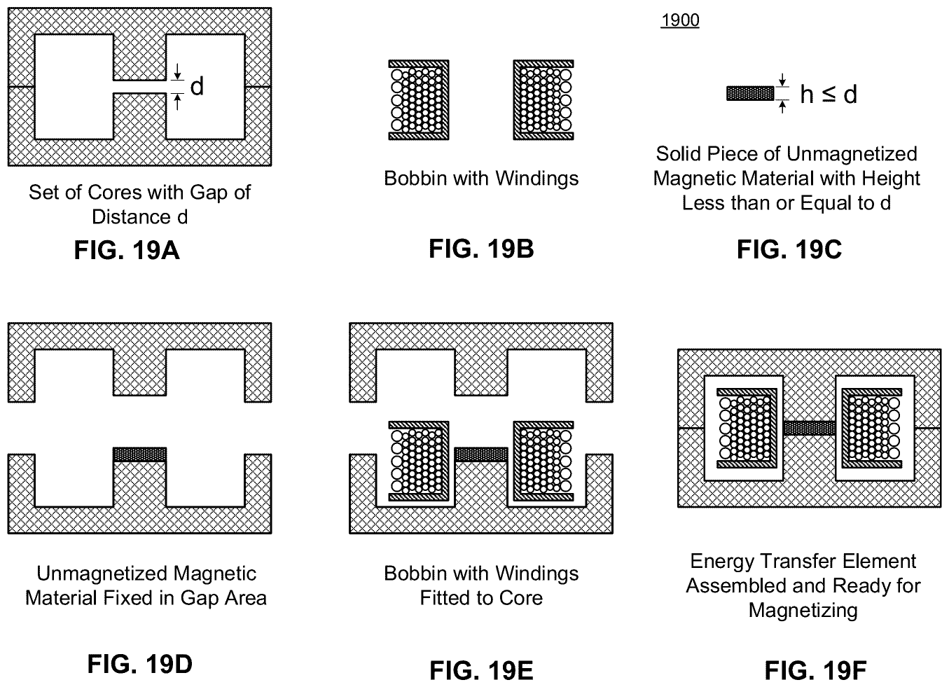

FIGS. 19A-19F illustrate the salient features of the construction of an energy transfer element 1900 having unmagnetized magnetic material, where the thickness is less than the gap between two core halves.

FIG. 19A illustrates a set of cores with a gap of distance d.

FIG. 19B illustrates a bobbin with windings. The primary power winding is reflected by the smaller circles wrapped closest to the spool of the bobbin. The secondary power winding is reflected by the large circles which are wrapped away from the spool of the bobbin.

FIG. 19C is a solid piece of unmagnetized magnetic material with a height less than or equal to distance d.

These materials include rare earth materials such as Neodymium Iron Boron (NdFeB) based material and Samarium Cobalt (SmCo) based material.

FIG. 19D shows the unmagnetized magnetic material fixed in the gap area.

FIG. 19E shows the bobbin with windings fitted to the core.

FIG. 19F illustrates an energy transfer element that is assembled with the solid piece of unmagnetized magnetic material.

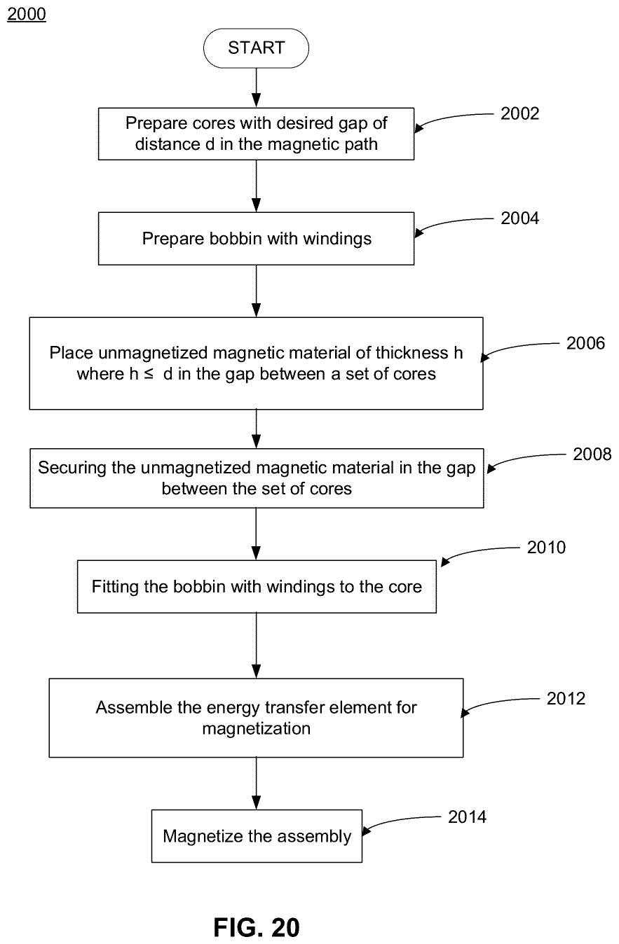

FIG. 20 illustrates a flowchart 2000 to assemble the energy transfer element 1900 shown in FIGS. 19A-19F.

In step 2002, the cores are prepared with a desired gap of distance d in the magnetic path.

In step 2004, the bobbin is prepared with windings.

In step 2006, unmagnetized magnetic material of thickness h, where h≤d, is placed in the gap between a set of cores.

In step 2008, the unmagnetized magnetic material is secured in the gap between the set of cores.

In step 2010, the bobbin with windings is fit to the core.

The order of steps 2008 and 2010 are interchangeable.

In step 2012, the energy transfer element is assembled.

In step 2014, the energy transfer assembly is magnetized.

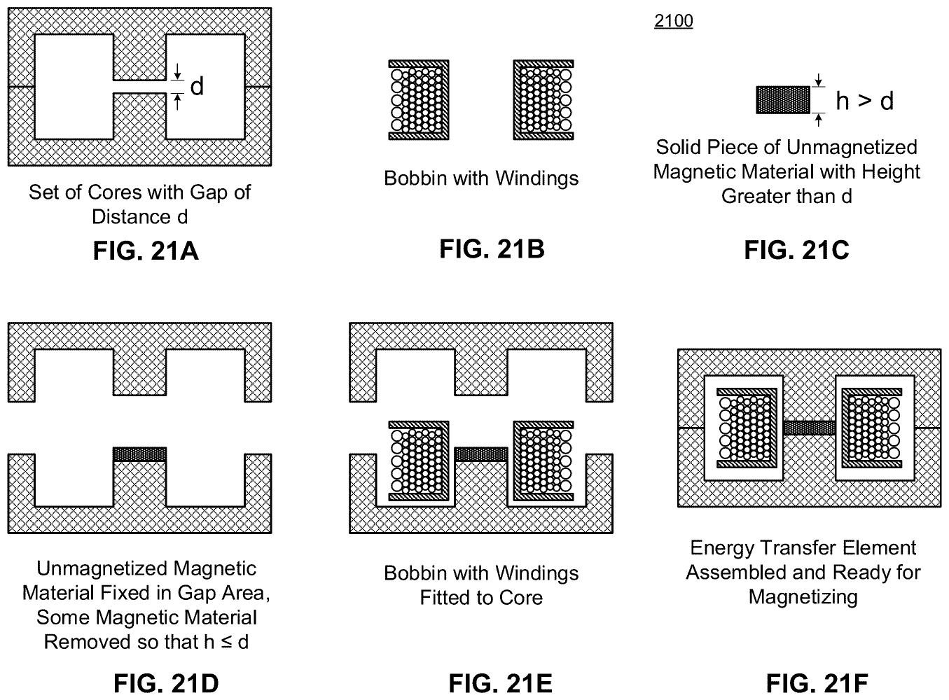

FIGS. 21A-21F illustrate the salient features of the construction of an energy transfer element 2100 having unmagnetized magnetic material in the gap having a thickness greater than the distance between two core halves.

FIG. 21A illustrates a set of cores with a gap of distance d.

FIG. 21B illustrates a bobbin with windings. The primary power winding is reflected by the smaller circles wrapped closest to the spool of the bobbin. The secondary power winding is reflected by the large circles which are wrapped away from the spool of the bobbin.

FIG. 21C is a solid piece of unmagnetized magnetic material with a height h greater than distance d.

These materials include rare earth materials such as Neodymium Iron Boron (NdFeB) based material and Samarium Cobalt (SmCo) based material.

FIG. 21D shows the unmagnetized magnetic material fixed in the gap area. Some of the magnetic material is removed so that h≤d. If the material is sufficiently hard, it may be ground to the correct thickness.

FIG. 21E shows the bobbin with windings fitted to the core.

FIG. 21F illustrates an energy transfer element that is assembled and ready for magnetizing.

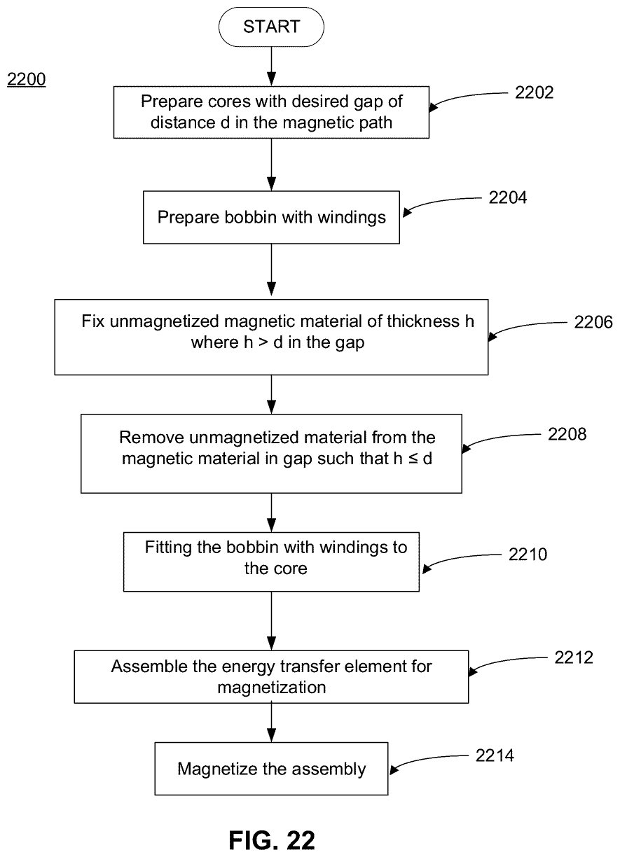

FIG. 22 illustrates a flowchart 2200 to assemble the energy transfer element 2100 shown in FIGS. 21A-21F.

In step 2102, the cores are prepared with a desired gap of distance d in the magnetic path.

In step 2104, the bobbin is prepared with windings.

In step 2106, unmagnetized magnetic material of thickness h, where h>d, is placed in the gap between a set of cores.

In step 2108, material is removed from the unmagnetized magnetic material such that h≤d.

In step 2110, the bobbin with windings is fit to the core.

In step 2112, the energy transfer element is assembled.

In step 2114, the energy transfer assembly is magnetized.

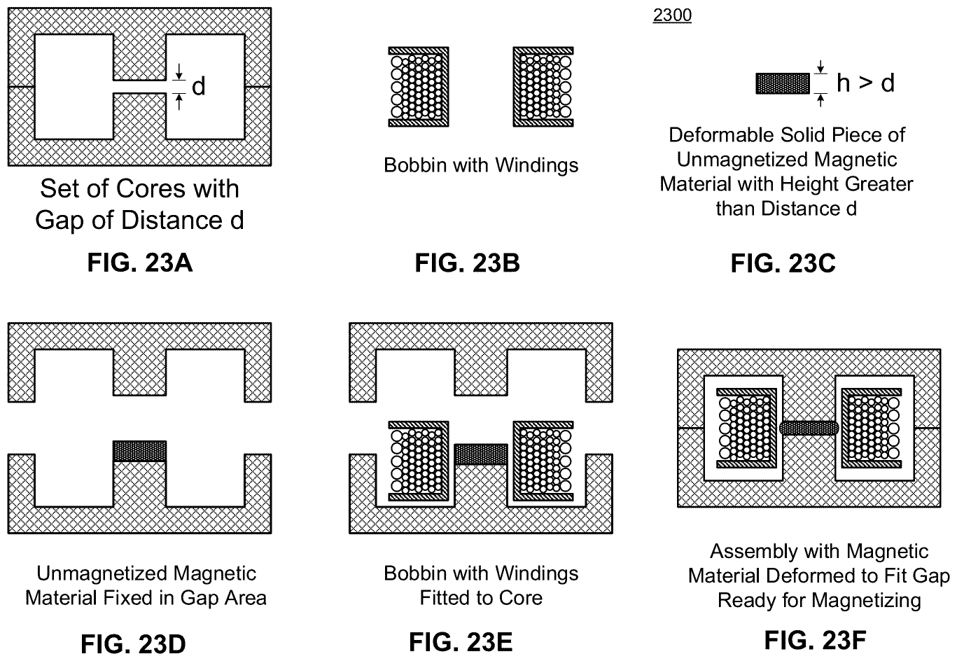

FIGS. 23A-23F illustrate the salient features of the construction of an energy transfer element 2300 having deformable unmagnetized magnetic material in the gap between the two core halves.

FIG. 23A illustrates a set of cores with a gap of distance d.

FIG. 23B illustrates a bobbin with windings. The primary power winding is reflected by the smaller circles wrapped closest to the spool of the bobbin. The secondary power winding is reflected by the large circles which are wrapped away from the spool of the bobbin.

FIG. 23C is a deformable solid piece of unmagnetized magnetic material with a height h greater than distance d. The material may be a mixture of unmagnetized magnetic powder and uncured adhesive. The mixture has the material properties of being substantially higher electrical impedance than the unmagnetized magnetic powder alone and adhesive. Initially, the mixture is in a compliant phase allowing for deformation under pressure for example and after curing, the mixture changes to a solid phase. The compliant phase has a viscosity such that the mixture maintains a uniform distribution of the unmagnetized powder. The solid phase may be a rigid solid that is non-rigid within a range of temperatures, e.g. glass. When the compliant phase is a non-rigid solid, it may deform in response to an assembling force that is elastic or inelastic.

FIG. 23D shows the unmagnetized magnetic material fixed in the gap area.

FIG. 23E shows the bobbin with windings fitted to the core.

FIG. 23F illustrates an energy transfer element that is assembled and ready for magnetizing.

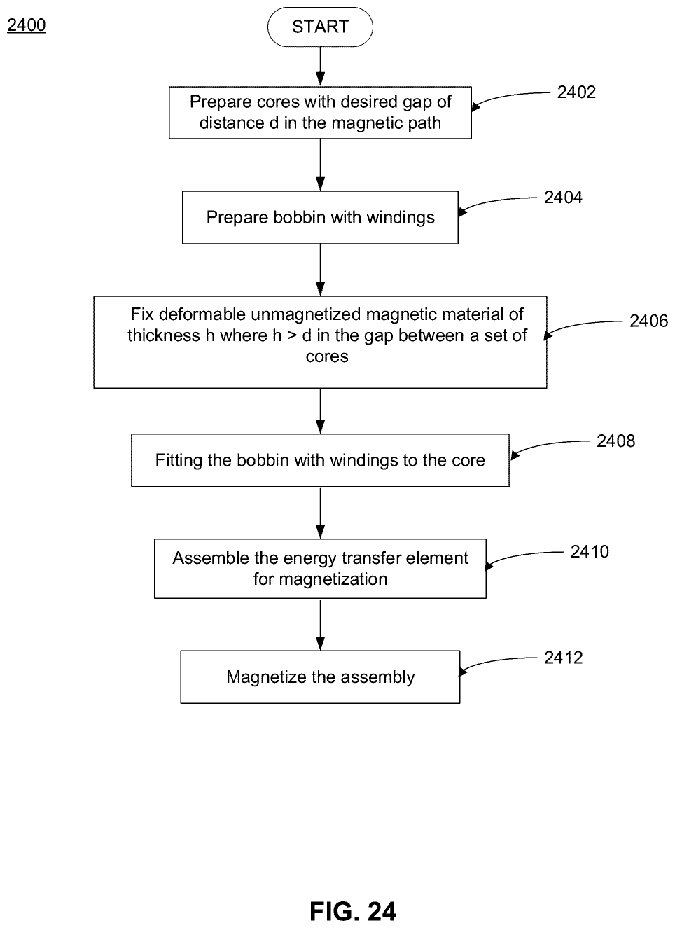

FIG. 24 illustrates a flowchart 2400 to assemble the energy transfer element shown in FIGS. 23A-23F.

In step 2402, the cores are prepared with a desired gap of distance d in the magnetic path.

In step 2404, the bobbin is prepared with windings.

In step 2406, the deformable unmagnetized magnetic material of thickness h, where h>d, is fixed in the gap between a set of cores.

In step 2408, the bobbin with windings is fit to the core.

The order of steps 2406 and 2408 are interchangeable.

In step 2410, the energy transfer element is assembled.

In step 2412, the energy transfer assembly is magnetized.

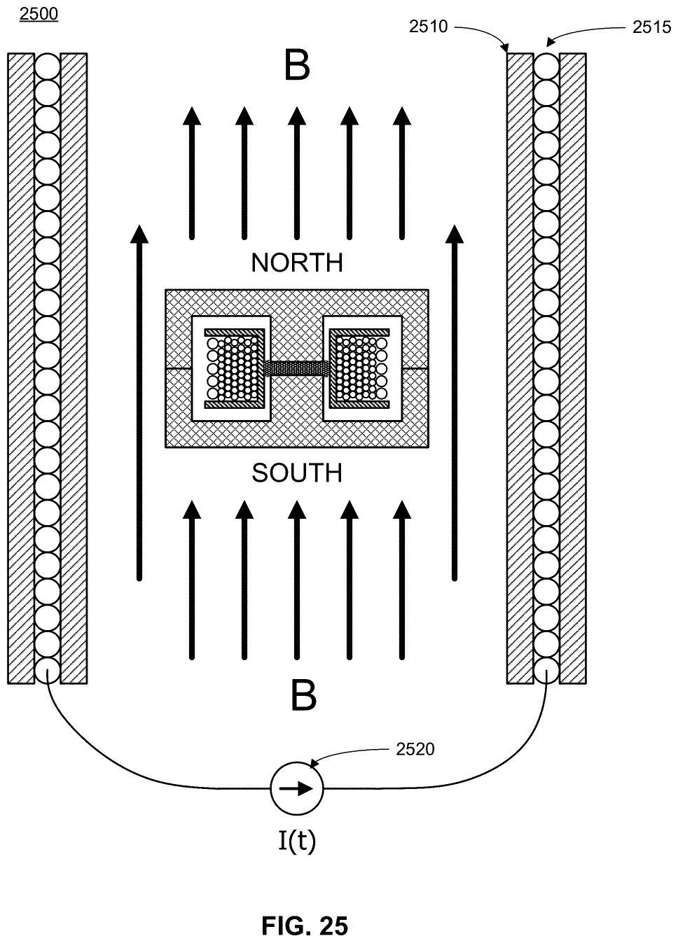

FIG. 25 illustrates a cross-section of a magnetizer 2500 for magnetizing the energy transfer elements disclosed above. The energy transfer element is placed inside the solenoid magnetizing fixture 2500. The solenoid magnetizing fixture 2500 is a double-walled cylinder 2510 that sandwiches a solenoid conductor, e.g. a coil of wire, 2515 between the walls. A current source 2520 applies a current that is passed through the solenoid conductor to generate a magnetic field of a magnitude suitable to magnetize the permanent magnet material. For NdFeB materials, the magnetic field is typically greater than 3 tesla.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, or similar parameters, are provided for explanation purposes and that other values may also be employed in other embodiments and examples in accordance with the teachings of the present invention.

Example 1: A method for making an energy transfer element comprising: adding one or more power windings to a magnetic structure that has a gap in its magnetic path; placing into the gap unmagnetized magnetizable material that produces an initial flux density in the magnetic path; applying a magnetic field to the magnetic structure such that the magnetizable material becomes magnetized, wherein the flux density produced by the magnetized material is offset from the initial flux density after the magnetic field is applied.

Example 2: The method of example 1, wherein placing into the gap unmagnetized magnetizable material comprises: applying a mixture comprising epoxy as a suspension medium and magnetizable particles; and curing the mixture.

Example 3: The method of example 2, wherein the volumetric ratio of magnetizable particles to suspension medium is greater than 1.

Example 4: The method of example 2, wherein curing the mixture comprises raising the temperature of the mixture to above a curing temperature associated with the suspension medium.

Example 5: The method of example 2, wherein curing the mixture comprises allowing time for the suspension medium to cure.

Example 6: The method of example 2, wherein curing the mixture further comprises irradiating the mixture.

Example 7: The method of example 1, wherein placing into the gap unmagnetized magnetizable material comprises: inserting an unmagnetized magnet into the gap.

Example 8: The method of example 1, wherein the magnetic structure is a toroid magnetic core.

Example 9: The method of example 1, wherein the magnetic structure comprises two core pieces separated by a gap and adding one or more power windings to the magnetic structure comprises: wrapping one or more power windings around a bobbin; and positioning the bobbin in the magnetic structure.

Example 10: The method of example 9, wherein placing into the gap unmagnetized magnetizable material comprises: inserting an unmagnetized magnet into the gap.

Example 11: The method of example 10, wherein the unmagnetized magnet is thicker than the gap, and inserting an unmagnetized magnet comprises: machining the unmagnetized magnet to fit the gap.

Example 12: The method of example 10, wherein the unmagnetized magnet is thinner than the gap, the method further comprising securing the unmagnetized magnet in the gap.

Example 13: The method of example 12, wherein securing the unmagnetized magnet in the gap comprises using an adhesive.

Example 14: The method of example 12, wherein the unmagnetized magnet is elastic and is thicker than the gap, and inserting an unmagnetized magnet comprises: applying an elastic force to secure the two core pieces.

Example 15: The method of example 1, wherein applying a magnetic field comprises: placing the energy transfer element inside a solenoid magnetizing fixture and passing a current through a solenoid conductor to produce a magnetic field of a magnitude suitable to permanently magnetize the magnetizable material.

Example 16: The method of example 1, further comprising varnishing the energy transfer element.

Example 17: An energy transfer element comprising: a magnetic core having a gap in a magnetic path; magnetizable material producing an initial flux density positioned in the gap; and one or more power windings wrapped around the magnetic path, wherein when the magnetizable material is magnetized the flux density produced by the magnetized material is offset from the initial flux density.

Example 18: The energy transfer element of claim 17, wherein the core is a toroid magnetic core.

Example 19: The energy transfer element of claim 18, wherein the magnetizable material is a mixture of a suspension medium comprising uncured epoxy and magnetizable particles.

Example 20: The energy transfer element of claim 19, wherein the magnetizable particles are selected from a group comprising Neodymium Iron Boron (NdFeB) based materials or Samarium Cobalt (SmCo) based material.

Example 21: The energy transfer element of claim 17, wherein the magnetizable material is an unmagnetized magnet.

Example 22: The energy transfer element of claim 17, the magnetic core comprising two core pieces.

Example 23: The energy transfer element of claim 22, wherein the magnetizable material comprises a mixture comprising a suspension medium that includes uncured epoxy and magnetizable particles.

Example 24: The energy transfer element of claim 23, wherein the magnetizable particles are selected from a group comprising Neodymium Iron Boron (NdFeB) based materials or Samarium Cobalt (SmCo) based material.

Example 25: The energy transfer element of claim 22, wherein the magnetizable material is an unmagnetized magnet.

Example 26: A structure for an energy transfer element comprising: a magnetic core having a gap in a magnetic path; and magnetizable material producing an initial flux density positioned in the gap, wherein when the magnetizable material is magnetized the flux density produced by the magnetized material is offset from the initial flux density.

Example 27: An energy transfer element comprising the structure of example 26 further including one or more power windings wrapped around the magnetic path.

What is claimed is:

1. A method for making an energy transfer element comprising:
adding one or more power windings to a magnetic structure that has a gap in a magnetic path;
placing into the gap an unmagnetized material that produces an initial flux density in the magnetic path;
applying a magnetic field to the magnetic structure such that the unmagnetized material becomes a magnetized material,
wherein a flux density produced by the magnetized material is offset from the initial flux density after the magnetic field is applied.

2. The method of claim 1, wherein placing into the gap the unmagnetized material comprises:
applying a mixture comprising epoxy as a suspension medium and magnetizable particles; and
curing the mixture.

3. The method of claim 2, wherein a volumetric ratio of the magnetizable particles to the suspension medium is greater than 1.

4. The method of claim 2, wherein curing the mixture comprises raising a temperature of the mixture above a curing temperature associated with the suspension medium.

5. The method of claim 2, wherein curing the mixture comprises allowing time for the suspension medium to cure.

6. The method of claim 2, wherein curing the mixture further comprises irradiating the mixture.

7. The method of claim 1, wherein placing into the gap the unmagnetized material comprises inserting an unmagnetized magnet into the gap.

8. The method of claim 1, wherein the magnetic structure is a toroid magnetic core.

9. The method of claim 1, wherein the magnetic structure comprises two core pieces separated by the gap and adding the one or more power windings to the magnetic structure comprises:
wrapping the one or more power windings around a bobbin; and
positioning the bobbin in the magnetic structure.

10. The method of claim 9, wherein placing into the gap the unmagnetized material comprises: inserting an unmagnetized magnet into the gap.

11. The method of claim 10, wherein the unmagnetized magnet is thicker than the gap, and inserting the unmagnetized magnet comprises: machining the unmagnetized magnet to fit the gap.

12. The method of claim 10, wherein the unmagnetized magnet is thinner than the gap, and the method further comprises: securing the unmagnetized magnet in the gap.

13. The method of claim 12, wherein securing the unmagnetized magnet in the gap comprises: using an adhesive.

14. The method of claim 12, wherein the unmagnetized magnet is elastic and is thicker than the gap, and inserting the unmagnetized magnet comprises: applying an elastic force to secure the two core pieces.

15. The method of claim 1, wherein applying the magnetic field comprises:
placing the energy transfer element inside a solenoid magnetizing fixture and passing a current through a solenoid conductor to produce the magnetic field of a magnitude suitable to permanently magnetize the unmagnetized material.

16. The method of claim 1, further comprising: varnishing the energy transfer element.
